(19) United States
(12) Patent Application Publication
(10) Pub. No.: US 2013/0215965 A1
(43) Pub. Date: Aug. 22, 2013

(54) VIDEO ENCODING AND DECODING USING AN EPITOME

(71) Applicant: Isabelle Amonou, Cesson Sevigne (FR)

(72) Inventor: Isabelle Amonou, Cesson Sevigne (FR)

(73) Assignee: FRANCE TELECOM, Paris (FR)

(21) Appl. No.: 13/881,643

(22) PCT Filed: Oct. 18, 2011
(86) PCT No.: PCT/FR11/52432

§ 371 Date: Apr. 25, 2013

(30) Foreign Application Priority Data
Oct. 25, 2010 (FR) 1058748

(51) Int. Cl. H04N 7/26

(52) U.S. Cl. CPC H04N 19/00569
USPC 375/240.12

(57) ABSTRACT

A method and apparatus are provided for encoding an image sequence. The method includes the following steps for at least one current image of the sequence, namely: construction of an epitome representative of the current image, from a set of at least two images from the sequence; and inter-image prediction of the current image from the epitome.

### CROSS-REFERENCE TO RELATED APPLICATIONS

This Application is a Section 371 National Stage Application of International Application No. PCT/FR2011/052432, filed Oct. 18, 2011, which is incorporated by reference in its entirety and published as WO 2012/056147 on May 3, 2012, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE INVENTION

The field of the invention is that of the encoding and decoding of images or sequences of images and especially of video streams.

More specifically, the invention pertains to the compression of images or of sequences of images using a blockwise representation of the images.

The invention can be applied especially to video encoding implemented in present-day video encoders (MPEG, H.264, etc and their amendments) or future video encoders (ITU-T/ISO HEVC or “High-Efficiency Video Coding”) and to the corresponding decoding.

### BACKGROUND

The digital images and sequences of images occupy a great deal of space in terms of memory and this makes it necessary, when transmitting these images, to compress them in order to avoid problems of congestion on the network used for this transmission. Indeed, the bit rate that can be used on this network is generally limited.

There are numerous video data compression techniques already known. Among these, the H.264 technique makes a prediction of pixels of a current image relative to other pixels belonging to the same image (intra prediction) or to a preceding or following image (inter prediction).

More specifically, according to this H.264 technique, the I images are encoded by spatial prediction (intra prediction) and the P and B images are encoded by time prediction relative to other I, P or B images (inter prediction), encoded/decoded by motion compensation for example.

To this end, the images are sub-divided into macro blocks, which are then sub-divided into blocks constituted by pixels. Each block or macro block is encoded by intra-image or inter-image prediction.

Classically, the encoding of a current block is achieved by means of a prediction of the current block, called a predicted block and a prediction residue corresponding to a difference between the current block and the predicted block. This prediction residue, also called a residual block, is transmitted to the decoder which rebuilds the current block by adding this residual block to the prediction.

The prediction of the current block is done by means of information already rebuilt (previous blocks already encoded/decoded in the current image, images preliminarily encoded in the context of a video encoding, etc). The residual block obtained is then transformed, for example by using a DCT (discrete cosine transform) type of transform. The coefficients of the transformed residual block are then quantified and then encoded by entropy encoding.

The decoding is done image by image and, for each image, it is done block by block or macro block by macro block. For each (macro) block the corresponding elements of the stream are read. The inverse quantification and the INverse transform of the coefficients of the residual block or blocks associated with the (macro) block are done. Then, the prediction of the (macro) block is calculated and the (macro) block is rebuilt by adding the prediction to the decoded residual block(s).

According to this compression technique, transformed, quantified and encoded residual blocks are transmitted to the decoder to enable it to rebuild the original image or images. Classically, in order to have same pieces of prediction information at the encoder and at the decoder, the encoder includes the decoder in its encoding loop.

In order to further improve image compression or image sequences, Q. Wang, R. Hu and Z. Wang in “Improving Intra Coding in H.264\AVC by Image Epitome, Advances in Multimedia Information Processing” have proposed a novel technique of intra prediction based on the use of epitomes or jigsaws.

An epitome is a condensed and generally miniature version of an image containing the main components of textures and contours of this image. The size of the epitome is generally reduced relative to size of the original image but the epitome always contains the constituent elements most relevant for rebuilding of the image. As described in the above-mentioned document, the epitome can be built by using a maximum likelihood estimation (MLE) type of technique associated with an expectation/maximization (EM) type of algorithm. Once the epitome has been built for the image, it can be used to rebuild (synthesize) certain parts of the image.

The epitomes are first of all used to analyze and synthesize images and videos. For this application, the synthesis known as the inverse synthesis is used to generate a texture sample (corresponding to the epitome) which best represents a wider texture. During the synthesis known as “direct” synthesis, it is possible to re-synthesize a texture of arbitrary size using this sample. For example, it is possible to re-synthesize the façade of a building from a sample of texture corresponding to a floor of the building or a window and its outline in the building. In the above-mentioned document, Q. Wang et al. have proposed to integrate such a inverse synthesis method into an H.264 encoder. The technique of intra prediction according to this document is based on the building of an epitome at the encoder. The prediction of the block being encoded is then generated from the epitome by a technique known as “template matching” which makes use of the search for a similar pattern in the epitome from known observations in a neighborhood of the zone to be rebuilt. In other words, the block of the epitome that possesses the neighborhood closest to that of the block being encoded is used for this prediction. This epitome is then transmitted to the decoder and used to replace the DC prediction of the H.264 encoder.

In this way, an overall piece of information on the image to be encoded is used for the intra prediction (the epitome being built from the entire image) and not only the causal neighborhood of the block being encoded. Furthermore, the use of an epitome for the intra prediction improves the compression of the data transmitted since the epitome is a condensed version of the image. Besides, the intra prediction implemented from an epitome does not assume an alignment of the blocks of the image.

However, although this technique of prediction offers high performance in terms of compression, it is not suited to the encoding of images or sequences of images of any type.

### SUMMARY

The invention proposes a novel method for encoding a sequence of images. According to the invention, such a method implements the following steps for at least one current image of the sequence:
building an epitome representing the current image, from a set of at least two images of the sequence;
inter-image predicting of the current image from the epitome.

Thus, the invention proposes a novel technique of inter-image prediction based on the generation and use at the encoder (and decoder intended for decoding the sequence of images) of a specific epitome or condensed image.

An epitome of this kind is built out of several images of the sequence and therefore represents a part of the sequence. The invention thus enables a more efficient prediction of the current image from this epitome.

The epitome thus built is not necessarily transmitted to the decoder and may be rebuilt by the decoder. In this way, the compactness of the data transmitted is improved. Thus, the invention reduces the bit rate needed for encoding a sequence of images without affecting their quality.

According to one variant, the epitome can be transmitted to the decoder which can use it as a reference image for its inter-image prediction. This variant also improves the compactness of the data transmitted since the epitome is a condensed version of at least two images according to the invention.

In particular, the current image and the set of images used to build the epitome belong to a same sub-sequence of the sequence.

A sub-sequence of this kind belongs to the group comprising:
a same image shot;
a GOP (group of pictures) comprising for example P and B type images located between two I type images according to the order of encoding of the sequence, as defined according to the H263, MPEG2, and other standards.

The set of images used to build the epitome can also be a list of reference images of the current image, defined for example according to the MPEG4, H.264 and other standards.

For example, to build the epitome, the invention uses a sub-sequence of images corresponding to a same scene or shot of a sequence of images as the current image. In this way, the different images of the sub-sequence have common characteristics which simplify the building of the epitome and enable its size to be reduced.

According to another characteristic of the invention, the step for building also takes account of the causal neighborhood of the current image. The epitome thus built represents the current image to the best possible extent.

According to one particular aspect of the invention, for the encoding of at least one image following the current image according to an order of encoding of the sequence, the method for encoding comprises a step for updating the set of images used to build the epitome, taking account of the context and/or progress of encoding in the sequence, and the updating of the epitome from the updated set.

In this way, it is not necessary to build a new epitome for each new image, thus reducing the quantity of operations to be performed. Furthermore, the epitome thus updated remains particularly representative of the sub-sequence of images.

For example, it is possible to update the epitome in taking account of an “image of difference” between the current image and an image following this current image, called a following image.

According to this aspect of the invention, the method for encoding comprises a step for transmitting a complementary epitome to at least one decoder intended for decoding the sequence of images, obtained by comparison of the epitome associated with the current image and the updated epitome associated with a following image.

In this way, the quantity of information to be transmitted to the decoder is reduced. Indeed, it is possible according to this aspect to transmit only the differences between the epitome associated with the current image and the updated epitome instead of transmitting the updated epitome.

According to one particular characteristic of the invention, the epitome has a size identical to the size of the current image.

In this way, it is not necessary to resize the motion vectors used for the inter-image prediction.

Furthermore, it is thus possible, for the prediction, to use a better quality epitome which can have greater volume inasmuch as it is not necessarily transmitted to the decoder. Indeed, since the size of the epitome can be chosen, it is possible to achieve a compromise between the quality of the rebuilding and compactness: the bigger the epitome, the higher the quality of the encoding.

In another embodiment, the invention proposes a device for encoding a sequence of images comprising the following means activated for at least one current image of the sequence:
means for building an epitome representing the current image, from a set of at least two images of the sequence;
means for inter-image predicting of the current image from the epitome.

Such an encoder is especially suited to implementing the method for encoding described here above. It may for example be an H.264 type video encoder. This encoding device could of course comprise the different characteristics of the method for encoding according to the invention. Thus, the characteristics and advantages of this encoder are the same as those of the method for encoding and shall not be described in more ample detail.

The invention also pertains to a signal representing a sequence of images encoded according to the method for encoding described here above.

According to the invention, such a signal is remarkable in that, with at least one current image of the sequence being predicted by inter-image prediction from an epitome representing the current image, built from a set of at least two images of the sequence, the signal carries at least one indicator signaling a use of the epitome during the inter-image prediction of the current image and/or a presence of the epitome in the signal.

Thus, such an indicator makes it possible to indicate, to the decoder, the mode of prediction used and to indicate whether it can read the epitome or a complementary epitome in the signal, or whether it should rebuild it.

This signal could of course comprise the different features of the method for encoding according to the invention.

The invention also pertains to a recording medium carrying a signal as described here above.

Another aspect of the invention relates to a method for decoding a signal representing a sequence of images implementing the following steps, for at least one image to be rebuilt:
obtaining an epitome representing the image to be rebuilt;
inter-image predicting of the image to be rebuilt from the epitome.

The invention thus makes it possible to retrieve the specific epitome at the decoder side and to predict the image to be rebuilt from this epitome. It therefore proposes a novel mode of inter-image prediction. To this end, the method for decoding implements the same step of prediction as the one implemented when encoding.

A method for decoding of this kind is especially suited to decoding a sequence of images encoded according to the method for encoding described here above. The characteristics and advantages of this method for decoding are therefore the same as those of the method for encoding, and shall not be described in more ample detail.

In particular, according to first embodiment, the step for obtaining implements a building of the epitome from a set of at least two images of the sequence. In particular, this set comprises a list of reference images of the image to be rebuilt. In other words, the epitome is not transmitted in the signal, and this improves the quality of the data (which can be predicted from an epitome of greater volume) and improves the compactness of the transmitted data.

According to a second embodiment, the epitome is built when encoding and is transmitted in the signal and the step for obtaining implements a step for reading the epitome in the signal.

As a variant, for the decoding of at least one image following the image to be rebuilt according to an order of decoding of the sequence, the method for decoding comprises a step for updating the epitome from a complementary epitome transmitted in the signal.

In another embodiment, the invention pertains to a device for decoding a signal representing a sequence of images comprising the following means activated for at least one image to be rebuilt:
means for obtaining an epitome representing the image to be rebuilt;
means of inter-image prediction of the image to be rebuilt from the epitome.

Such a decoder is adapted especially to implementing the previously described method for decoding. It may for example be an H.264 type video decoder.

This decoding device could of course include the different characteristics of the method for decoding according to the invention.

The invention also pertains to a computer program comprising instructions for implementing a method for encoding and/or a method for decoding as described here above when this program is executed by a processor. Such a program can use any programming language whatsoever. It can be downloaded from a communications network and/or recorded on a computer-readable carrier.

### BRIEF DESCRIPTION OF THE DRAWINGS

Other features and advantages of the invention shall appear more clearly from the following description of a particular embodiment, given by way of a simple, illustratory and non-exhaustive example, and from the appended drawings, of which:

FIGS. 1 and 2 present the main steps implemented respectively when encoding and when decoding according to the invention;

FIG. 3 illustrates an example of an embodiment of an encoder according to FIG. 1;

FIGS. 4, 5A and 5B present examples of building of an epitome;

FIGS. 6 and 7 present the simplified structure of an encoder and a decoder according to one particular embodiment of the invention.

### DESCRIPTION OF ONE EMBODIMENT OF THE INVENTION

1. General Principle

The general principle of the invention relies on the use of a specific epitome for predicting at least one inter-image of a sequence of images. More specifically, an epitome of this kind is built out of several images of the sequence and therefore represents a part of the sequence. The invention thus enables more efficient encoding of the inter-image.

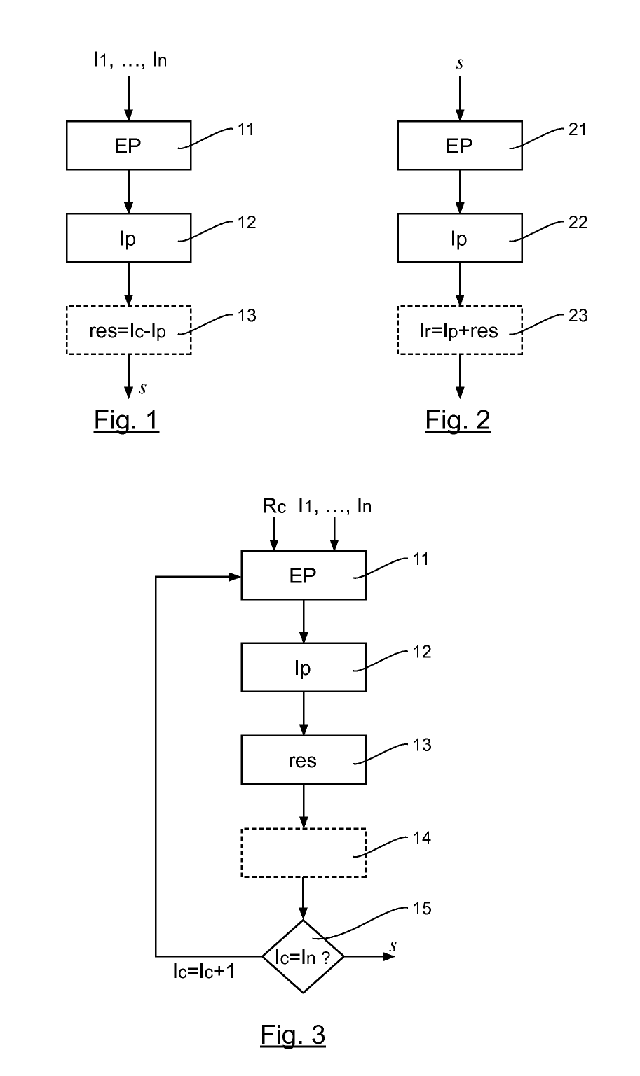

FIG. 1 illustrates the main steps implemented by an encoder according to the invention.

Such an encoder receives a sequence of images I1 to In at input. Then, for at least one current image Ic of the sequence, it builds (11) an epitome EP representing the current image from a set of at least two images of the sequence. The current image and the set of images used to build the epitome EP are considered to belong to a same sub-sequence of the sequence, comprising for example images belonging to a same shot or a same GOP or a list of reference images of the current image. The epitome EP is built so as to truly represent this sub-sequence of images.

During the following step, the encoder implements an inter-image type prediction 12 of the current image, on the basis of the epitome EP. Such a prediction implements for example a motion compensation or a “template matching” type technique applied to the epitome and delivers a predicted image Ip.

It is then possible, during an encoding step 13, to encode the prediction residue obtained by comparison between the current image Ic and the predicted image Ip.

FIG. 2 illustrates the main steps implemented by a decoder according to the invention.

Such a decoder receives a signal representing a sequence of images at input. It implements the step for obtaining 21, for at least one image Ir to be rebuilt, an epitome EP representing the image to be rebuilt and, as the case may be, a prediction residue associated with the image to be rebuilt.

During a following step, the decoder implements an inter-image type of prediction of the image to be rebuilt, on the basis of the epitome EP.

It is then possible to rebuild the image Ir during a step for decoding 23 in adding the prediction residue to the image obtained at the end of the prediction step 22.

According to a first embodiment, the epitome used for encoding the current image Ic is not transmitted to the decoder. The step for obtaining 21 then implements a step for building the epitome from at least two images of the sequence, similar to the one implemented by the encoder.

According to a second embodiment, the epitome used for the encoding of the current image Ic is transmitted to the decoder. This step for obtaining 21 then implements a step for reading the epitome in the signal.

2. Example of an Embodiment

Here below, referring to FIGS. 3 to 5B, we describe a particular example of an embodiment of the invention in the context of an encoder according to the H.264 standard.

2.1 Encoder Side

We consider a video encoder receiving a sequence of images I1 to In at input, as well as a target resolution level defined as a function of the size of the epitome. Indeed, it may be recalled that it is possible to achieve a compromise between the quality of the rebuilding and compactness depending on the size of the epitome: the bigger the epitome, the higher is the quality of encoding. It can be noted that the size of the epitome corresponds most to the sum of the sizes of the images of the set used to generate the epitome. An efficient compromise is that of choosing the size of an image of this set, as the target size for the epitome. If, for example, a reference list comprising eight images is used to generate the epitome, then in this case we obtain an epitome of accurate quality while gaining a factor of compaction equal to eight.

A) Building of the Epitome

At the step for building 11, the encoder builds, for at least one current image Ic of the sequence, an epitome EP representing the current image, from a set of at least two images of the sequence.

The set of images of the sequence processed jointly to build the epitome can be chosen prior to the step for building 11. These are for example images belonging to a same shot as the current image.

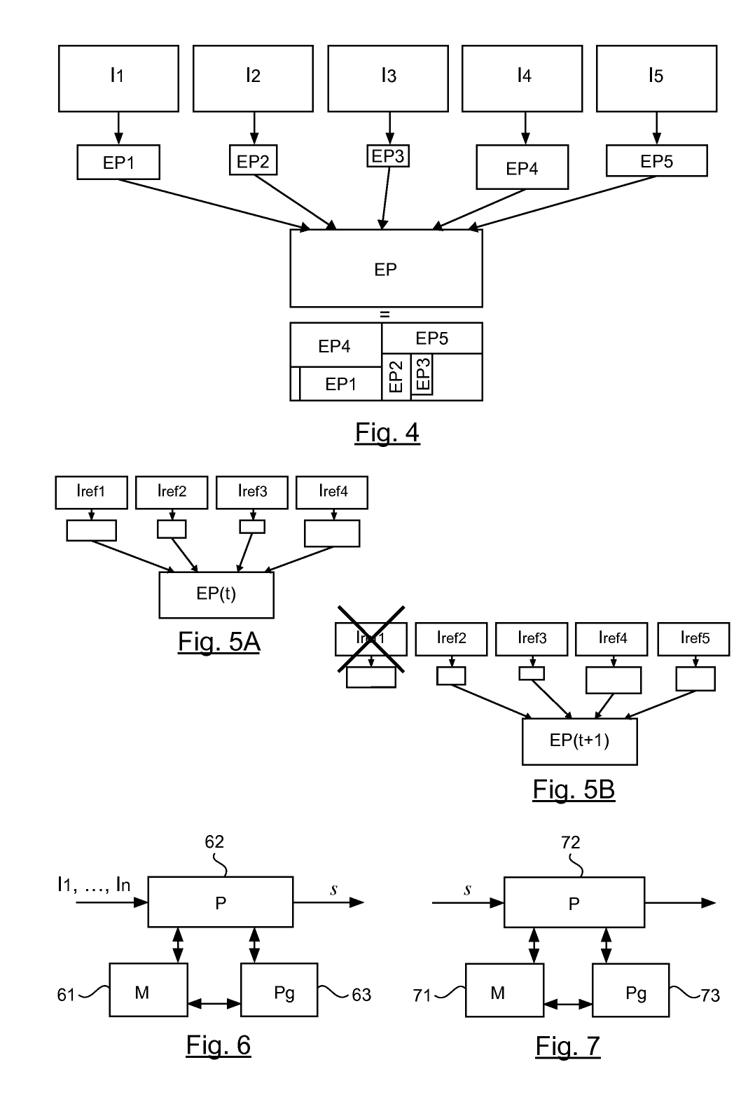

We consider for example a sub-sequence comprising the images I1 to I5 and the current image Ic. The epitome used to predict the current image Ic is built from the images I1 to I5. To this end, as illustrated in FIG. 4, epitomes associated with each of the images I1 to I5, respectively denoted as EP1 to EP5, are determined in using a classic technique of building epitomes, such as the maximum likelihood type of technique as presented by Q. Wang et al. in “Improving Intra Coding in H.264\AVC by Image Epitome, Advances in Multimedia Information Processing”. Then, these different epitomes EP1 to EP5 are “concatenated” to build the “overall” epitome EP used to predict the current image Ic. Such a technique of “concatenation” of epitomes is presented especially in H. Wang, Y. Wexler, E. Ofek, and H. Hoppe “Factoring repeated content within and among images” and proposes to nest the epitomes EP1 to EP5 so as to obtain an overall epitome EP that is as compact as possible. In this technique, the elements (sets of pixels, blocks) common to the different epitomes EP1 to EP5 are taken only once in the overall epitome EP. Thus, the overall epitome EP has a size which, most, is equal to the sum of the sizes of the epitomes EP1 to EP5.

According to one variant, the encoder builds the epitome by using a dynamic set, i.e. a list of images in which images are added and/or withdrawn according to the context and/or the progress of the encoding in the sequence. The epitome is therefore computed gradually for each new image to be encoded belonging to a same shot, a same GOP, etc.

For example, as illustrated in FIGS. 5A and 5B, the encoder builds the epitome in using a list of reference images of the current image Ic being encoded, as defined in the H.264 standard.

For example, as illustrated in FIG. 5A, four images Iref1 to Iref4 are in the list of reference images of the current image Ic. These four images are then used to generate the epitome EP at the instant t in using for example the technique of concatenation proposed by H. Wang et al.

At the instant t+1, as illustrated in FIG. 5B, for the encoding of an image of the sub-sequence following the current image Ic in the order of encoding, the first image Iref of the list of reference images is withdrawn and a new image Iref5 is added in the list of reference images. The epitome EP is then updated from the updated list of reference images. It is thus possible, in this variant, to refine the “overall” epitome for each new image to be encoded belonging to a same shot, a same GOP, etc. Thus, the epitome EP at the instant t+1 is generated from the four images Iref2 to Iref5 corresponding to the three former images Iref2 to

Iref4 used to generate the epitome at the instant t and to the new image Iref5. The epitome computed on the basis of the new reference image Iref5, denoted as a complementary epitome, could be transmitted at the instant t+1 to the decoder instead of the overall epitome EP(t+1).

Naturally, other techniques for building the epitome EP from several images can also be envisaged.

In particular, the step for building 11 can also take account of the causal neighborhood of the current image, in addition to the existing images of the sub-sequence, to build the epitome EP.

At the end of this step for building 11, we therefore obtain an “overall” epitome EP or a complementary epitome EPc associated with the current image Ic.

B) Inter Prediction from the Epitome

We then determine an inter-image type prediction of the current image, denoted as Ip, during the step 12, from the epitome EP.

Such a prediction implements for example a motion compensation from the epitome. In other words, the epitome EP thus built is considered to be a reference image, and the current image Ic is predicted from the motion vectors pointing from the current image towards the epitome EP (backward compensation) or from the epitome towards the current image (forward motion compensation).

As a variant, such a prediction implements a “template matching” type technique applied to the epitome. In this case, the neighborhood (target “template” or “model”) of a block of the current image is selected. In general, these are pixels forming an L (“L-shape”) above and to the left of this block (target block). This neighborhood is compared with equivalent shapes (source “templates” or “models”) in the epitome. If a source model is close to the target model (according to a criterion of distance), the corresponding block of the source model is used as a prediction of the target block.

C) Encoding and Transmission of the Image

It is then possible, during an encoding step 13, to encode the prediction residue obtained by comparison between the current image Ic and the predicted image Ip.

D) Encoding and Transmission of the Epitome

The step for encoding and transmitting the epitome 14 is optional.

Indeed, according to a first embodiment, the epitome EP used for encoding the current image Ic is not transmitted to the decoder. This epitome is however regenerated at the decoder on the basis of the previously encoded/decoded images of the sequence and possibly of the causal neighborhood of the current image.

According to a second embodiment, the epitome EP, or a complementary epitome EPc, used for the encoding of the current image Ic is transmitted to the decoder. In this case, it is no longer necessary to add, to the image being encoded, the reference frame number of the image or images that classically serve as a reference for its prediction.

E) End of Encoding Algorithm

If the current image is the last image of the sequence of images (test 15, Ic=In?), the encoding algorithm is stopped.

If not, the operation passes to the image following the current image in the sequence according to the encoding order (Ic+1) and the operation returns to the step 11 for building the epitome for this new image.

It can be noted that the step 12 for predicting could implement another mode of encoding, for at least one image of the sequence. Indeed, the mode of encoding chosen for the prediction is the mode that offers the best compromise between bit rate and distortion from among all the pre-existing modes and the mode of encoding based on the use of an epitome according to the invention.

In particular, the step 12 for predicting can implement another mode of encoding for at least one block of an image of the sequence if the prediction is implemented block by block.

Thus, as a variant, the step 12 for predicting can be preceded by a test to determine whether the mode of rebuilding using motion vectors from the epitome (denoted as M_EPIT) is the best for each block to be encoded. If this is not the case, the step 12 for predicting can implement another prediction technique.

2.2 Signal Representing the Image Sequence

The signal generated by the encoder can carry different pieces of information depending on whether or not the epitome or a complementary epitome is transmitted to the decoder for at least one image of the sequence.

Thus, for example, such a signal comprises at least one indicator to signal the fact that a epitome is used to predict one or more images of the sequence, that an epitome or several epitomes are transmitted in the signal, that a complementary epitome or several complementary epitomes are transmitted in the signal, etc.

It can be noted that the epitomes or complementary epitomes which are image data can be encoded in the signal as images of the sequence.

2.3 Decoder Side

The main steps implemented at the decoder have already been described with reference to FIG. 2.

More specifically, the decoder implements a step 21 for obtaining, for at least one image Ir to be rebuilt, an epitome EP representing the image to be rebuilt.

According to a first embodiment, the epitome used for the encoding of the current image Ic is not transmitted to the decoder. For example, in the signal representing the sequence of images, the decoder reads at least one indicator signaling the fact that an epitome has been used to predict the image to be rebuilt and that this epitome is not transmitted in the signal.

The decoder then implements a step for building the epitome EP from at least two images of the sequence, similar to that implemented by the previously described encoder.

As in the case of the encoder, the epitome can be built by using a dynamic set, i.e. a list of images in which images are added and/or removed as a function of the context and/or progress of the decoding in the sequence. The epitome is therefore computed gradually for each new image to be rebuilt belonging to a same shot, a same GOP, etc.

For example, the decoder builds the epitome by using a list of reference images of the image being decoded, as defined in the H.264 standard.

According to a second embodiment, the epitome used for the encoding of the current image Ic is transmitted to the decoder. For example, in the signal representing the image sequence, the decoder reads at least one indicator signaling the fact that an epitome has been used to predict the image to be rebuilt and that this epitome, or a complementary epitome, is transmitted in the signal.

The decoder then implements a step for reading the epitome EP or a complementary epitome in the signal.

More specifically, it is considered that, for the first image to be rebuilt of a sub-sequence, the epitome EP is received. Then, for at least one image to be rebuilt following the first image to be rebuilt in the sub-sequence according to the decoding order, a complementary epitome is received, enabling the epitome EP to be updated.

Once the epitome has been obtained, the decoder implements a prediction of the image to be rebuilt. If the image to be rebuilt or at least one block of the image to be rebuilt has been predicted when encoding from the epitome (mode M_EPIT), the prediction step 22 implements an inter-image type prediction from the epitome, similar to that implemented by the previously described encoder.

Thus, a prediction of this kind implements for example a motion compensation or a “template matching” technique from the epitome.

The decoder therefore uses the epitome as a source of alternative prediction for the motion estimation.

3. Structure of the Encoder and the Decoder

Finally, referring to FIGS. 6 to 7, we present the simplified structure of an encoder and a decoder respectively implementing a technique for encoding and a technique for decoding according to one of the embodiments described here above.

For example, the encoder comprises a memory 61 comprising a buffer memory M, a processing unit 62 equipped for example with a processor P and driven by at least one computer program Pg 63 implementing the method for encoding according to the invention.

At initialization, the code instructions of the computer program 63 are for example loaded into a RAM and then executed by the processor of the processing unit 62. The processing unit 62 inputs a sequence of images to be encoded. The processing unit 62 implements the steps of the method for encoding described here above according to the computer program instructions 63 to encode at least one current image of the sequence. To this end, the encoder comprises, in addition to the memory 61, means for building an epitome representing the current image from a set of at least two images of the sequence and means of inter-image prediction of the current image from the epitome. These means are driven by the processor of the processing unit 62.

The decoder for its part comprises a memory 71 comprising a buffer memory M, a processing unit 72, equipped for example with a processor P and driven by a computer program Pg 73, implementing the method for decoding according to the invention.

At initialization, the code instructions of the computer program 73 are for example loaded into a RAM and then executed by the processor of the processing unit 72. The processing unit 72 inputs a signal representing the sequence of images. The processor of the processing unit 72 implements the steps of the method for decoding described here above according to the instructions of the computer program 73 to decode and rebuild at least one image of the sequence. To this end, the decoder comprises, in addition to the memory 71, means for obtaining an epitome representing the image to be rebuilt and means of inter-image prediction of the image to be rebuilt from the epitome. These means are driven by the processor of the processing unit 72.

Although the present disclosure has been described with reference to one or more examples, workers skilled in the art will recognize that changes may be made in form and detail without departing from the scope of the disclosure and/or the appended claims.

1. A method comprising: encoding a sequence of images with an encoding device, wherein encoding, characterized implements the following steps for at least one current image of said sequence:
building an epitome representing said current image, from a set of at least two images of said sequence; and
inter-image predicting of said current image from said epitome.

2. The method according to claim 1 wherein said step of building also takes account of a causal neighborhood of said current image.

3. The method according to claim 1 wherein the method comprises a step for of transmitting said epitome to at least one decoder intended for decoding said sequence of images.

4. The method according to claim 1 wherein, for the encoding of at least one image following said current image according to an order of encoding of said sequence, the method comprises a step of updating said set and updating said epitome from said updated set.

5. The method according to claim 4, wherein the method comprises a step of transmitting a complementary epitome to at least one decoder intended for decoding said sequence of images, said complementary epitome being obtained by comparison of said epitome and said updated epitome.

6. The method according to claim 1, wherein said epitome has a size identical to the size of said current image.

7. A device for encoding a sequence of images, the device comprising:
an input for receiving the sequence of images;
an output delivering an epitome representing at least one current image of the sequence of images;
a processor device, which is configured to perform the following steps, which are activated for the at least one current image of the sequence:
the epitome representing said current image, from a set of at least two images of said sequence; and
inter-image predicting said current image from said epitome.

8. A method comprising:
encoding a sequence of images with an encoder to produce a signal, wherein at least one current image of said sequence is predicted by inter-image prediction from an epitome representing said current image, built from a set of at least two images of said sequence, and wherein said signal carries at least one indicator signaling a use of said epitome during the inter-image prediction of said current image and/or a presence of said epitome in said signal; and
transmitting the signal from the encoder.

9. A method comprising:
decoding a signal representing a sequence of images with a decoding device, wherein decoding implements the following steps, for at least one image to be rebuilt:
obtaining an epitome representing said image to be rebuilt; and
inter-image predicting of said image to be rebuilt from said epitome.

10. The method according to claim 9, wherein said step of obtaining implements building said epitome from a set of at least two images of said sequence.

11. The method according to claim 9, wherein, said epitome is built when encoding the sequence of images and the method comprises:
receiving the epitome in said signal by the decoding device, and wherein said step of obtaining implements a step of reading said epitome in said signal.

12. The method according to claim 9 wherein, for the decoding of at least one image following said image to be rebuilt according to an order of decoding of said sequence, said method comprises a step of updating said epitome from a complementary epitome transmitted in said signal.

13. A device for decoding a signal representing a sequence of images, the device comprising:
an input for receiving the signal;
an output delivering the sequence of images;
a processor device, which is configured to perform the following steps, which are activated for at least one of the images to be rebuilt:
obtaining an epitome representing said image to be rebuilt; and
inter-image predicting the image to be rebuilt from said epitome.

14. A non-transitory computer-readable recording medium comprising a computer program recorded thereon and comprising instructions for implementing a method for encoding a sequence of images when this program is executed by a processor, wherein the instructions comprise:
instructions that configure the processor to implement a step of building an epitome representing a current image of said sequence, from a set of at least two images of said sequence; and
instructions that configure the processor to implement a step of inter-image predicting of said current image from said epitome.

15. A non-transitory computer-readable recording medium comprising a computer program recorded thereon and comprising instructions for implementing a method for decoding a signal representing a sequence of images when this program is executed by a processor, wherein the instructions comprise:
instructions that configure the processor to implement a step of obtaining an epitome representing said image to be rebuilt; and
instructions that configure the processor to implement a step inter-image prediction of said image to be rebuilt from said epitome.
